(19) United States
(12) Patent Application Publication
(10) Pub. No.: US 2005/0246078 A1
(43) Pub. Date: Nov. 3, 2005

(54) Automatically guided vehicle with improved navigation

(76) Inventor: Jan Vercammen, Geel (BE)

Correspondence Address: BACON & THOMAS, PLLC, 625 SLATERS LANE, FOURTH FLOOR, ALEXANDRIA, VA, 22314, US

(21) Appl. No.: 10/958,338

(22) Filed: Oct. 6, 2004

(30) Foreign Application Priority Data
Apr. 30, 2004 (BE) 2004/0216

(51) Int. Cl. G01C 22/00

(52) U.S. Cl. 701/23; 701/28; 180/167; 318/587

(57) ABSTRACT

Automatically guided vehicle (AGV) with improved navigation which is provided with at least one measuring system for a relative position finding, characterized in that it is also provided with two or more measuring systems to determine the absolute position of the vehicle (1).

### BACKGROUND OF THE INVENTION

1. Field of the invention

The present invention concerns an automatically guided vehicle with improved navigation.

Such an automatically guided vehicle (AGV) is used for example in warehouses to automatically handle goods during the storage or when taking the delivery out of the warehouse, whereby this vehicle is linked to a central warehouse computer, for example via a wireless connection, from where the vehicle receives instructions to for example pick up outgoing goods from the warehouse or to store incoming goods in the warehouse.

Also in production environments, such automatically guided vehicles are applied in the assembly to move work pieces, tools and the like.

2. Discussion of the Related Art

It is known that such automatically guided vehicles are usually equipped with one or several sensors, for example sensors to determine the position, sensors to detect obstacles or the like, which are connected to a processing unit and whereby the above-mentioned processing unit is connected to at least one actuator, for example in the shape of one or several motors to drive or to control the vehicle, to grasp objects or the like.

In known automatically guided vehicles, the above-mentioned measuring sensors at least consist of one or several sensors to carry out relative measurements in relation to a starting position.

Relative measurements comprise for example relative distance measurements, based on the number of revolutions made by the wheels and which are measured by means of an encoder or the like, and relative measurements of the angular displacement of the vehicle, which is measured for example in the known manner by means of potentiometers on a steering wheel.

By means of the above-mentioned measurements, the position and orientation of the automatically guided vehicle is calculated, whereby in practice, however, there will always remain deviations in relation to the actual orientation of the vehicle due to irregularities in the floor, wear of the wheels and the like.

Sensors for the relative position finding in the shape of a gyroscope for measuring the angular velocity of the vehicle are also known, such that orientation changes can be observed and can be compared to for example the above-mentioned measurements of the potentiometers.

Relative measuring sensors are usually not precise enough as such, since they calculate every new position of the vehicle on the basis of a preceding position, so that all positions are in fact determined on the basis of a single starting position. After some time, this may result in large deviations due to the accumulation of measuring errors, as a result of which such relative measuring sensors are not suitable as such for the correct navigation of automatically guided vehicles.

Automatically guided vehicles are also known which are equipped with an absolute measuring system making use of a sensor for absolute position finding.

Absolute measurements make use of one or several external points of reference in the working space, which can be detected by means of a suitable sensor on the automatically guided vehicle. On the basis of these measurements, the absolute position and orientation of the vehicle can be calculated, independently of the route that was followed before by the vehicle.

A disadvantage of the known automatically guided vehicles with such an absolute measuring system is that every absolute measuring system is only fit to be applied in certain conditions, as a result of which the flexibility regarding the implementation of such automatically guided vehicles is strongly limited.

Another disadvantage of such an absolute measuring system is that the accuracy, depending on the selected system, can be relatively limited, so that precise maneuvers and operations are not possible in certain cases.

An example of such an absolute measuring system consists of a known laser navigation system which scans the environment with a laser beam in search of reflectors which are erected in fixed positions in the working space to thus determine the absolute position.

However, such laser navigation is not fit to be applied in warehouses with narrow passages and pallets that are stacked high and the like, since it is difficult to place reference reflectors there and since the view on the points of reference may be disturbed.

Moreover, such laser navigation is not fit to be applied in case of an uneven floor, since the reflectors are then out of reach of the scanning laser beam.

Another disadvantage is that the above-mentioned laser navigation cannot be applied when for example light-sensitive material for photo's or the like must be handled.

Another disadvantage of the above-mentioned laser navigation is that it cannot be applied outside and that the installation of such a laser navigation system is relatively complex and expensive.

Another known absolute navigation technique makes use of a magnet sensor which works in conjunction with magnets that are for example provided in the floor.

A disadvantage thereof is that these magnets must be fit in the floor, which is not possible just anywhere.

Another disadvantage is that such a measuring system on the basis of magnet sensors does not function well when the floor is dirty and that the above-mentioned reference magnets may hold magnetic particles.

Another known technique for measuring the absolute position and the orientation of an automatically guided vehicle consists of the known wire navigation, whereby electric conductors are provided in the floor through which an electric current is applied which generates an induction field that is detected by means of an antenna on the automatically guided vehicle.

A disadvantage of such a navigation system with conductive wires fit in the floor is that the installation of the reference wires is precision work which can only be done by qualified personnel, and which moreover implies that, for the installation, the activities in the working space must be stopped for a certain time.

In order to remedy the above-mentioned disadvantages, automatically guided vehicles already exist which are provided with a combination of an absolute measuring system and one or several relative measuring systems.

Such known automatically guided vehicles that are provided with a combination of one or several relative measuring systems with a single absolute measuring system are disadvantageous in that in case of a defect of the absolute measuring system, the vehicle can only function further on the basis of less correct relative measurements.

Another disadvantage of such automatically guided vehicles that are provided with a combination of an absolute measuring system and one or several relative measuring systems is that the specific restrictions of the above-mentioned absolute measuring systems always remain as such, which strongly limits the possibilities for implementing such automatically guided vehicles with a single absolute measuring system.

### SUMMARY OF THE INVENTION

The present invention aims to provide a solution to one or several of the above-mentioned disadvantages.

To this aim, the invention concerns an automatically guided vehicle (AGV) with an improved navigation which is provided with at least one measuring system for a relative position finding, characterized in that it is also provided with two or more measuring systems to determine the absolute position of the vehicle.

This is advantageous in that absolute measurement data are still being obtained in case of a defect or in case one of the absolute measuring systems breaks down, thanks to the presence of a second absolute measuring system.

Another advantage thereof is that, by combining the different absolute and relative measurement data, more precision can be obtained regarding the absolute position and orientation of the automatically guided vehicle in the working space.

An additional advantage is that, for example when using two absolute measuring systems of the same type, the sample frequency of the measured values is increased, as a result of which the position precision and the positioning speed increase.

Such an automatically guided vehicle according to the invention is preferably also provided with means which make it possible to evaluate the strength and/or reliability of the incoming signals of the sensors and to exclude the signals lacking strength or precision, or to take them less into account for the position finding.

In zones of the working space where two or more absolute measuring systems are active, the strongest signal can be selected, such that in this manner at least one measuring system is always available, which selected measuring system will then automatically provide the most appropriate and precise absolute measurement data.

The above-mentioned measuring systems for absolute position finding preferably at least consist of a combination of two or more of the following absolute measuring systems:
a laser navigation system;.
a camera navigation system;
a magnetic navigation system;
a wire navigation system;
a satellite navigation system;
an optical navigation system.

This is advantageous in that the uses regarding implementation of such an automatically guided vehicle according to the invention in an existing working environment strongly increase, even for strongly varying and difficult work situations, by combining the different existing absolute navigation techniques, as described above.

### BRIEF DESCRIPTION OF THE DRAWINGS

In order to better explain the characteristics of the invention, the following preferred embodiment of an automatically guided vehicle with improved navigation according to the invention is described as an example only without being limitative in any way, with reference to the accompanying figures, in which:

FIG. 1 schematically represents an automatically guided vehicle according to the invention in perspective;

FIG. 2 schematically represents a control circuit, as applied in an automatically guided vehicle according to the invention;

FIG. 3 represents a block diagram of the operation of an automatically guided vehicle according to the invention.

### DESCRIPTION OF A PREFERRED FORM OF EMBODIMENT

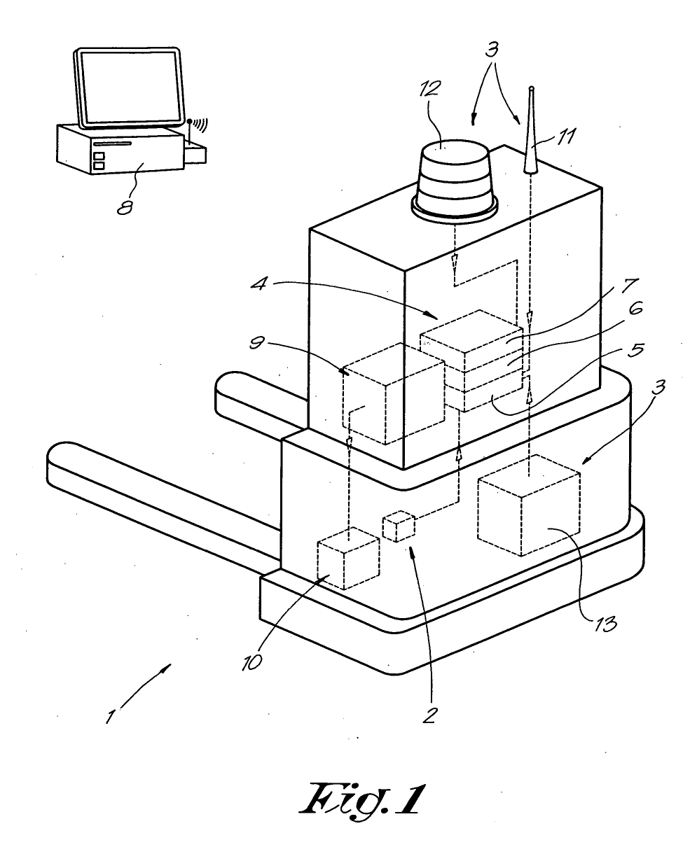

FIG. 1 represents an automatically guided vehicle 1 according to the invention which is mainly built in the known manner, in this case in the shape of a forklift.

The automatically guided vehicle 1 is in this case provided with one relative measuring sensor 2 and with three absolute measuring sensors 3, which are all connected to a processing unit 4, more specifically to a navigation module 5 which is part thereof.

The above-mentioned processing unit 4, which is made for example in the shape of an industrial computer, is also provided with an arithmetic module 6 and a communication module 7.

The above-mentioned communication module 7 is connected to a central warehouse computer 8 in the known manner via a preferably wireless connection.

The above-mentioned arithmetic module 6 forms a connection between the navigation module 5 on the one hand and the communication module 7 on the other hand, and it is connected to a control unit 9 with one port.

The above-mentioned control unit 9 is connected to one or several actuators 10, for example in the shape of a driving or steering motor of the automatically guided vehicle 1.

The above-mentioned absolute measuring sensors 3 in this case consist of a satellite receiver for a satellite positioning system such as GPS, Galileo or the like, which is schematically represented here by means of an antenna 11, a laser scanner 12 for laser navigation which can work in conjunction with reflectors applied in fixed positions in the working space and a magnet sensor 13 for magnetic navigation which can work in conjunction with magnets fit for example in the floor of the working space, and which are all built in the conventional manner and are not further described here.

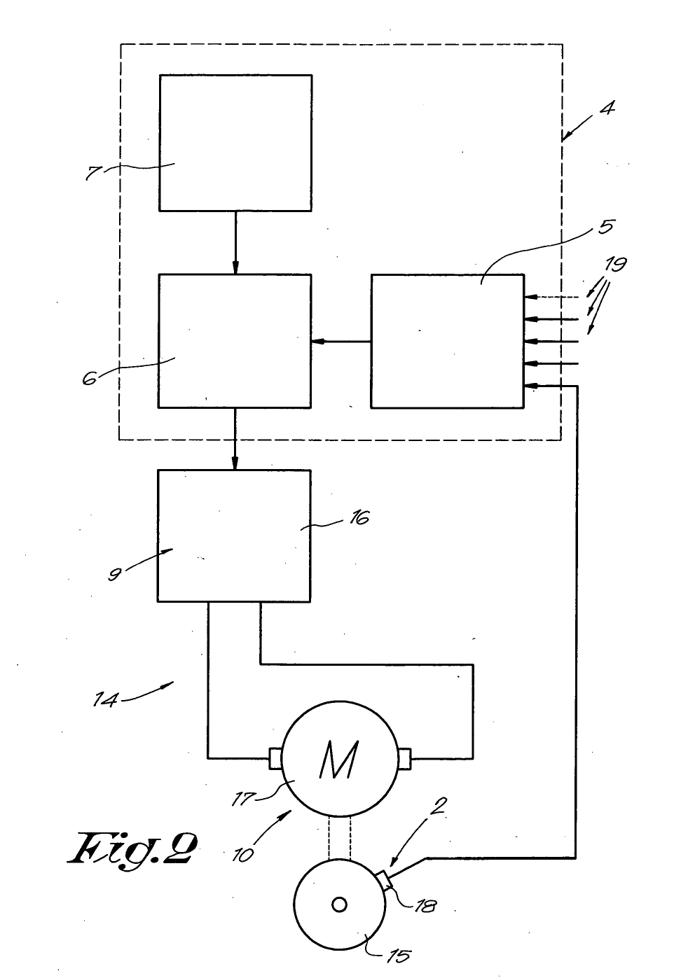

FIG. 2 schematically represents a control circuit 14 for driving a wheel 15 of an automatically guided vehicle 1 according to the invention, whereby the above-mentioned control unit 9 consists of a conventionally applied so-called four quadrant chopper 16 controlling an electric driving motor 17 of the wheel 15.

On the wheel 15 is also provided a relative measuring sensor-2 in the shape of an encoder 18, which is connected to the above-mentioned navigation module 5 of the processing unit 4.

As already described above, the navigation module 5 is connected to the above-mentioned arithmetic module 6, together with the above-mentioned communication module 7, and the port of the above-mentioned arithmetic module 6 is connected to the above-mentioned control unit 9, such that a closed control circuit 14 is created.

The above-mentioned navigation module 5 is, as represented in FIG. 2, also provided with connections 19 to connect at least two of the above-mentioned absolute measuring sensors 3.

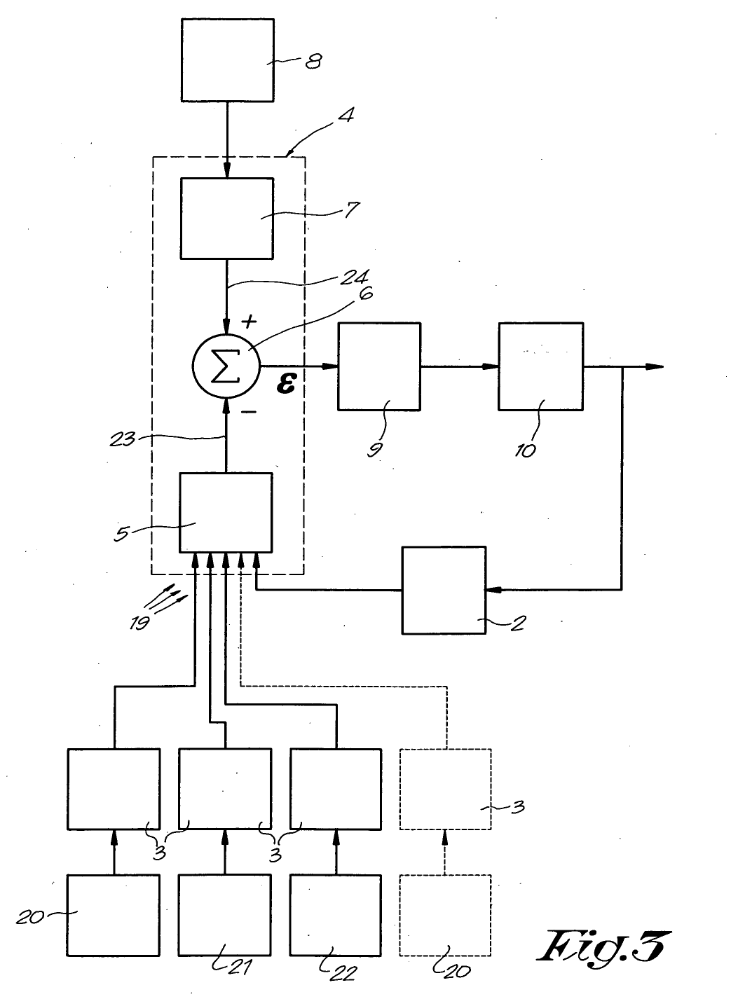

The working of such an automatically guided vehicle 1 according to the invention is very simple and is schematically represented in FIG. 3.

The absolute measuring sensors 3 continuously carry out measurements in the known manner in relation to external points of reference which in this case consist of the above-mentioned reflectors 20, magnets 21 and a satellite 22.

The relative measuring sensors 2 also continuously carry out measurements in relation to the starting position of the automatically guided vehicle 1.

The measuring signals of the above-mentioned relative and absolute measuring sensors 2-3 are carried to the above-mentioned navigation module 5.

In the above-mentioned navigation module 5, the different measuring signals are compared and the actual position of the automatically guided vehicle 1 is determined.

The above-mentioned navigation module 5 can thereby function in different ways.

A first possibility is that the navigation module 5 compares the different measuring results and uses the most reliable value to calculate the actual position of the automatically guided vehicle 1.

A second possibility is that the navigation module 5 takes into account all the received measuring signals of the relative and of the absolute measuring sensors 2-3 to calculate the most probable position and orientation of the automatically guided vehicle 1 according to the invention. Use can be made to this end for example of what is called a KALMAN filter.

The outgoing signal 23 of the navigation module 5, which signal comprises all data related to the actual position and orientation of the vehicle 1, is compared to the ideal value 24 of the position and orientation in the arithmetic module 6, which is transmitted by the above-mentioned communication module 7.

In order to be able to determine this ideal value 24, the above-mentioned central warehouse computer 8 transmits data related to the target location of the automatically guided vehicle 1, after which the above-mentioned communication module 7 of the arithmetic module 6 calculates the most appropriate route for the automatically guided vehicle 1.

The deviation ε between both signals 23-24 is hereby determined, whereby the above-mentioned processing unit 4 sends a signal to the above-mentioned control unit 9 on the basis of said deviation ε.

The control unit 9 in turn activates the actuators 10 which are connected to this control unit 9.

In the example of FIG. 2, the above-mentioned control unit 9 consists of the chopper 16 which controls the driving motor 17 for the wheel 15.

When it is found that there is a deviation ε between the measured and the desired position, the driving motor 17 will be driven just as long until the deviation ε between the above-mentioned ideal value 24 and the actual measured value 23 of the position is zero.

The above-mentioned relative measuring sensors 2 are preferably calibrated in a dynamical manner by means of measurement data of one or several of the above-mentioned absolute measuring sensors 3.

In the above-mentioned example, the above-mentioned encoder 18, which is provided on the wheel 15 of the automatically guided vehicle 1, can for example be calibrated on the basis of absolute measurement data of one or several of the absolute measuring sensors 3.

This calibration reckons with wear of the wheels 15, which, without the above-mentioned correction, would result in that the distance measurement of the above-mentioned relative sensor 2 decreases in time.

Means are preferably provided which are part of the above-mentioned navigation module 5 en which make it possible to evaluate the strength and/or the reliability of the incoming signals of the sensors 2-3 and to exclude the signals which lack strength or precision from the position finding.

This is advantageous in that, when the first measuring system is omitted, it is always possible to switch over to a second measuring system.

The above-mentioned processing unit 4 can in this manner preferably switch over seamlessly from one absolute measuring system to another one and thereby always select the most appropriate measuring system for a specific environment.

According to the invention, it is possible to register deviations between the above-mentioned relative and absolute measurements, and to detect wear or defects of parts, on the basis of continuous or constantly returning deviations, for example of the sensors 2-3, of the actuators 10 and/or of moving parts such as wheels 15 and the like of the automatically guided vehicle 1.

The automatically guided vehicle 1 according to the invention represented in the figures is equipped with a laser navigation system, a satellite navigation system and a magnetic navigation system, but also other combinations are possible.

In a preferred embodiment of an automatically guided vehicle 1 according to the invention, the above-mentioned absolute measuring system at least consists of the combination of a laser navigation system and a wire navigation system.

This is advantageous in that the flexibility of the laser navigation is combined with the extreme accuracy of a wire navigation system, whereby one or both systems can always be activated.

Another advantage is that, for example in an area where light-sensitive material is being treated, use can be made of the wire navigation and that in another area, where much flexibility is required, the known laser navigation can be applied. An application of such a combination of laser and wire navigation is found for example when an automatically guided vehicle 1 has to travel from a production environment with an open view to a warehouse where pallets and the like are stacked high.

In another preferred embodiment of an automatically guided vehicle 1 according to the invention, the above-mentioned absolute measuring system consists of the combination of a laser navigation-system and a magnetic navigation system.

An advantage thereof is that on those places where no laser navigation can be used, such as when treating photo-sensitive material, and on those places where it is physically difficult to apply laser navigation because of obstacles limiting the view, magnetic navigation can be applied.

Another advantage thereof is that, when the laser scanner 12 detects too few beacons of reference to have the position module make a complete position and orientation calculation, the measurement data of this laser scanner 12 can nevertheless be used, to calculate a more precise position and orientation in combination with the data of the magnet sensor 13 than when using only the measurement data of the magnet sensor 13.

An additional advantage thereof is that, in those places where laser navigation can be applied, the flexibility of this navigation method can be used to the full, which is impossible when using only magnetic navigation.

In another preferred embodiment, the above-mentioned absolute measuring system at least consists of the combination of a satellite navigation system and a laser navigation system.

An advantage of this embodiment is that such a vehicle 1 is fit to move, on the basis of satellite navigation, outside a building without any beacons of reference having to be provided hereby. Such an automatically guided vehicle 1 according to the invention can hereby be applied inside as well as outside.

Another advantage of such an automatically guided vehicle 1 is that it has the flexibility of the laser navigation system at its disposal inside a building.

It is clear that also other combinations of measuring systems to determine the absolute position are possible, such as for example the combination of a camera navigation system and a magnetic navigation system, a satellite navigation system and a magnetic navigation system, a satellite navigation system and a wire navigation system or the like, whereby a combination of the above-mentioned advantages is each time obtained and whereby the application possibilities of an automatically guided vehicle 1 according to the invention strongly increase.

The present invention is by no means limited to the above-described embodiment, given as an example and represented in the accompanying figures; on the contrary, such an automatically guided vehicle 1 with improved navigation according to the invention can be made in all sorts of shapes and dimensions while still remaining within the scope of the invention.

1. An automatically guided vehicle (AGV) with improved navigation which is provided with at least one measuring system for a relative position finding, wherein it is also provided with two or more measuring systems to determine the absolute position of the vehicle.

2. The automatically guided vehicle according to claim 1, wherein the above-mentioned measuring systems to determine the absolute position are of a different type.

3. The automatically guided vehicle according to claim 1, wherein the above-mentioned measuring systems for absolute position finding at least comprise the combination of two or more of the following absolute measuring systems:
a laser navigation system;
a camera navigation system;
a magnetic navigation system;
a wire navigation system;
a satellite navigation system;
an optical navigation system.

4. The automatically guided vehicle according to claim 1, wherein the above-mentioned measuring systems for absolute position finding at least comprise the combination of three or more of the above-mentioned absolute measuring systems.

5. The automatically guided vehicle according to claim 1, wherein the above-mentioned absolute measuring systems at least comprise the combination of a laser navigation system and a wire navigation system.

6. The automatically guided vehicle according to claim 1, wherein the above-mentioned absolute measuring systems at least comprise the combination of a laser navigation system and a magnetic navigation system.

7. The automatically guided vehicle according to claim 1, wherein the above-mentioned absolute measuring systems at least comprise the combination of a laser navigation system and a satellite navigation system.

8. The automatically guided vehicle according to claim 1, wherein the above-mentioned absolute measuring systems at least comprise the combination of a camera navigation system and a magnetic navigation system.

9. The automatically guided vehicle according to claim 1, wherein the above-mentioned absolute measuring systems at least comprise the combination of a satellite navigation system and a magnetic navigation system.

10. The automatically guided vehicle according to claim 1, wherein the above-mentioned absolute measuring systems at least comprise the combination of a satellite navigation system and a wire navigation system.

11. The automatically guided vehicle according to claim 1, wherein the above-mentioned absolute measuring systems at least comprise the combination of a camera navigation system, a magnetic navigation system and a satellite navigation system.

12. The automatically guided vehicle according to claim 1, wherein means are provided which make it possible to evaluate the strength and/or reliability of the incoming signals of the sensors and to exclude those signals which lack strength or precision, or to take them less into account for the position finding.
